(19) United States
(12) Patent Application Publication
(10) Pub. No.: US 2023/0135353 A1
(43) Pub. Date: May 4, 2023

(54) BATTERY SYSTEM AND VEHICLE INCLUDING THE BATTERY SYSTEM

(71) Applicant: SAMSUNG SDI CO., LTD., Yongin-si (KR)

(72) Inventor: Bernhard HADLER, Feldkirchen/Graz (AT)

(21) Appl. No.: 17/975,496

(22) Filed: Oct. 27, 2022

(30) Foreign Application Priority Data
Oct. 28, 2021 (EP) 21205222.9
Oct. 26, 2022 (KR) 10-2022-0139192

(51) Int. Cl. H01M 50/358; H01M 50/289

(52) U.S. Cl. CPC H01M 50/358; H01M 50/289; H01M 2220/20

(57) ABSTRACT

A battery system includes: a battery housing; a plurality of battery cells arranged in a plurality of battery cell groups within the battery housing; and a separation sheet. Each battery cell group has a venting side with a venting exit configured to vent a venting stream from the battery cells to exit the battery cell group, and the separation sheet is at venting sides of the battery cell groups. The separation sheet forms separate venting chambers for each of the battery cell groups and is configured to guide the venting stream leaving the venting exits away from the battery cell groups through openings in the separation sheet.

### CROSS-REFERENCE TO RELATED APPLICATION

This application claims priority to and the benefit of European Patent Application No. 21205222.9, filed in the European Patent Office on Oct. 28, 2021, and Korean Patent Application No. 10-2022-0139192, filed in the Korean Intellectual Property Office on Oct. 26, 2022, the entire content of both of which are incorporated herein by reference.

### BACKGROUND

### 1. Field

Aspects of embodiments of the present disclosure relate to a battery system and a vehicle including the battery system.

### 2. Description of the Related Art

Recently, vehicles for transportation of goods and peoples have been developed that use electric power as a source for motion. Such an electric vehicle is an automobile that is propelled by an electric motor using energy stored in rechargeable (or secondary) batteries. An electric vehicle may be solely powered by batteries or may be a hybrid vehicle powered by, for example, a gasoline generator. Furthermore, the vehicle may include a combination of an electric motor and a conventional combustion engine.

Generally, an electric-vehicle battery (EVB, or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter provides an irreversible conversion of chemical to electrical energy. Low-capacity rechargeable batteries are used as power supply for small electronic devices, such as cellular phones, notebook computers, and camcorders, while high-capacity rechargeable batteries are used as power supply for hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent group of electric vehicles in development.

Rechargeable batteries may be used as a battery module formed of a plurality of unit battery cells coupled to each other in series and/or in parallel to provide a high energy density, such as for motor driving of a hybrid vehicle. For example, the battery module may be formed by interconnecting the electrode terminals of the plurality of unit battery cells in an arrangement or configuration depending on a desired amount of power and to realize a high-power rechargeable battery.

Battery modules can be constructed in either a block design or a modular design. In the block design, each battery is coupled to a common current collector structure and a common battery management system, and the unit thereof is arranged in a housing. In the modular design, pluralities of battery cells are connected to form submodules, and several submodules are connected to form the battery module. In automotive applications, battery systems often consist of a plurality of battery modules connected to each other in series to provide a desired voltage. The battery modules may include submodules with a plurality of stacked battery cells, and each stack may include cells connected in parallel that are, in turn, connected in series (XpYs) or cells connected in series that are, in turn, connected in parallel (XsYp).

A battery pack is a set of any number of (often identical) battery modules. They may be configured in a series, parallel or a mixture of both to deliver the desired voltage, capacity, or power density. Battery packs include the individual battery modules and the interconnects, which provide electrical conductivity between them.

Battery systems, according to the related art, despite any modular structure, usually include a battery housing that acts as enclosure to seal the battery system against the environment and provides structural protection to the battery system's components. Housed battery systems are usually mounted as a whole into their application environment, such as into an electric vehicle.

A thermal management system may be used to efficiently emit, discharge and/or dissipate heat generated within the battery housing to provide thermal control of the battery cells enclosed within the battery housing. In certain conditions, an increase in the internal temperature of the battery cells can lead to abnormal reactions occurring in the battery cells. An example of such abnormal operation conditions is a thermal runaway, which is a condition that a battery cell may enter due to a significantly overheated or overcharged cell. The thermal runaway is a self-accelerating chemical reaction inside the battery cell, which produces high amount of heat and venting gas, often continuing until nearly all available material is exhausted. The exhausted material, such that the venting products, may include hot, toxic venting gas as well as potentially conductive solid material, like graphite powder and metal fragments.

The temperature of the venting products, including the venting gas, can reach about 1000° C. or even higher, in particular when several battery cells enter into thermal runaway at the same time or within a short time span. The temperature of the venting products is usually still very high when leaving the battery system through the system venting element to the environment. This presents a danger for bystanders because the hot venting products may cause burns and may ignite, causing a fire.

Some battery system venting concepts let the hot venting products of battery cells in thermal runaway condition expand into the battery housing and exit the battery system through a system venting element to the environment of the battery housing. As the venting products escape the battery system, the pressure inside the battery system can be kept in a safe range. The system venting element can be dimensioned according to, for example, ISO 4126-6. However, with such designs, the venting stream can transfer heat and/or particles onto other cells or electrically conductive parts, which can lead to a thermal propagation or short circuit, causing a thermal runaway of other cells leading to a damage of the whole battery pack and, possibly, the vehicle.

### SUMMARY

Embodiments of the present disclosure overcome or reduce at least some of the drawbacks of the related art and provide a battery system that reduces or minimizes the danger of burns and fire in a simple and cost-efficient manner.

A battery system for a vehicle, such as an electric or hybrid vehicle, includes a battery housing and a plurality of battery cells within the battery housing. The battery housing may enclose the plurality of battery cells in a cell chamber. The battery cells are arranged in groups. Such a group may be defined by the spatial proximity of its constituent cells; for example, the cells of one group may be closer to each other than to the cells of different groups. In addition or alternatively, such a group may be defined by its constituent cells being electrically interconnected in a specific manner, such as in series or in parallel. For example, each battery cell group may form a cell stack. A plurality of these cell stacks may form a (sub)module of the battery system.

Each battery cell group has a venting side with at least one venting exit. The venting side may also be considered the venting side of all of the battery cells of the battery system. For example, the battery cells groups may have the same venting side. In an installation setting (e.g., in an installed state) where the battery system is installed in a vehicle, the venting side may be, for example, the top side of the battery cells or the bottom side thereof. In the event of a thermal runaway condition, a venting stream including venting products exits the battery cell group at the venting side through the venting exit(s).

In related art venting methods, the venting streams of all of the battery cells directly enter the cell chamber or a joint venting channel and flow unguided through the battery housing exiting the battery system through a system venting element to the environment of the battery housing. This may cause the venting stream to transfer heat and/or particles onto other cells or electrically conductive parts, which could lead to a thermal propagation or short circuit, causing a thermal runaway of further cells.

In a battery system according to embodiments of the present disclosure, a separation sheet forms separate venting chambers for each of the battery cell groups. The separation sheet is arranged at the venting sides of the battery cell groups and forms one venting chamber for each of the battery cell groups. For example, one separation sheet provides (or forms) multiple separate venting chambers, one for each battery cell group. The venting chambers are separate in the sense that a venting stream being vented by a battery cell group into one of the chambers does not (e.g., is directed to not) enter the neighboring venting chambers. Thus, each of the battery cell groups has its own venting chamber into which its venting stream, in case of, as an example, a thermal runaway, is directed into. Thus, for each battery cell group, at least one venting exit of the respective battery cell group adjoins the respective venting chamber. The venting chamber may be formed by the separation sheet in conjunction with the venting side of battery cell group. For example, each venting may be delimited at a first side by the venting side of the battery cell group and at a second side opposite the first side by the separation sheet.

The separation sheet is configured to guide the venting streams leaving the venting exits away from the battery cell groups through openings in the separation sheet. The openings in the separation sheet are arranged such that each of the venting chamber has (or corresponds to) at least one opening. Thus, each of the venting chambers has an opening to allow the venting stream to exit the respective venting chamber. The separation sheet may be act as a (venting) baffle, that is, as an obstruction or guiding element directing the stream of venting products exiting the venting exit away from the respective battery cell group through the respective opening in the separation sheet/venting chamber. The separation sheet may be formed such that the venting stream may be directed away from the cells more or less resistance free. The separation sheet may have guiding surfaces to guide the venting stream from the venting exit along the venting side and through the opening in the separation sheet, as will be explained in more detail below. The separation sheet may be configured to guide the venting stream leading the venting exit along at least a part of the venting side towards the opening. The opening may be arranged at a side end of the venting chamber. The separation sheet may include or consist of a deep drawn metal (e.g., it may be partially or entirely produced via deep drawing of a metal sheet, such as a steel sheet). By such a drawing process, the venting chambers and/or the openings may be formed.

Thus, the venting stream does not directly enter a common/joint venting channel for venting all of the venting streams of all of the cells. Instead, the venting stream is first vented into a separate venting chamber. These venting chambers reduce the pressure of the respective venting stream by using the thermal mass of these chambers and the surrounding parts to reduce the initial venting stream temperature. Further, due to the dedicated venting chambers, the venting streams are channeled away from the battery cells including away from the main high voltage package area. The venting geometry, according to embodiments of the present disclosure, provides sufficient cool-down of the venting products before leaving the respective venting chamber so that the risk of damaging other cells via heat propagation is reduced. Also, the venting chambers shield the respective battery cells group from a venting stream leaving another cell chamber because one venting stream cannot enter other venting chambers. For example, the venting products exiting a battery system according to an embodiment of the present disclosure towards the environment are at a relatively low temperature.

Due to the separation sheet, the venting streams of the battery cells do not directly enter the cell chamber (e.g., do not enter a joint venting channel) but rather first enter the respective venting chamber first. However, the venting streams may be guided from each of the venting chambers into a joint venting channel, which guides the venting stream(s) outside the battery system via a system exit. Thus, according to an embodiment, the battery system includes a cover element facing the venting side of the battery cell groups and the separation sheet arranged between the cover element and the venting side. A venting channel is arranged (or formed) between the separation sheet and the cover element and connects (e.g., fluidly connects) a system exit of the battery housing with the venting chambers via the openings in the separation sheet. The separation sheet may thus, in conjunction with the cover element, form a joint venting channel for all of the venting streams leaving the separate venting chambers. At a first side of the separation sheet, the venting chambers may be formed in conjunction with the venting sides of the battery cell groups, while at a second side of the separation sheet facing away from the first side, the joint venting channel may be formed in conjunction with the cover element. Thus, the pre-cooled venting streams exiting the venting chambers through the respective opening are merged into one venting stream, thereby providing a controlled venting path to the system exit and to the environment of the battery system. The venting streams are, thus, not only guided from their venting exits through their venting chambers but also through the joint venting channel.

According to an embodiment, the cover element is a bottom cover. The bottom cover may be part of an underbody or underride protection of the battery housing. For example, an underbody or underride protection may form the bottom cover. Accordingly, in an installation setting, the battery system is arranged such that the venting side is a bottom side, for example, such that it faces downward. The venting streams may, thus, exit the cells downwardly into the adjacent venting chambers. Such an arrangement may allow for the venting streams to be guided while gravity assists with the flow. Also, such an arrangement may provide better contact of the venting stream with the walls of the venting chamber and, therefore, to better cooling of the venting stream. In some embodiments, a cooling plate may be provided at the venting side of the battery cells, and the venting stream may transfer a significant amount of heat to the cooling plate. The cooling plate may have venting holes or venting valves as venting exits for allowing the venting stream to leave the respective battery cell group.

According to an embodiment, the battery cell groups are supported by the separation sheet. For example, the separation sheet may hold or carry the battery cells groups inside the battery housing. The battery cell groups may be arranged on the separation sheet. The separation sheet may be configured to hold the battery cell groups, and the separation sheet may include a fixture (or structure) for fixing the battery cells to the separation sheet. This may allow for an easy installation of the battery cells groups in the battery housing while also providing (or forming) the venting chambers. This way, the separation sheet may provide (or form) the venting chambers and may support the battery cell groups. Known supporting sheets for supporting the battery cells groups may be used as separation sheets but need to be configured to provide the venting chambers. For example, the sheets may be deep drawn to form the venting chambers, the openings, and/or the guiding surfaces. Thus, no additional parts need to be added to the battery system so that the costs stay more or less the same.

According to an embodiment, the separation sheet forms a structural member of the battery system. For example, the separation sheet may be a structural member of the battery system. The separation sheet may form such a structural member by being configured to support the battery cells as explained above. As a structural member the separation sheet may, however, not only support the battery cells but may also provide stability to the battery system as a whole. For example, the separation sheet may be a cross strut. In that regard, the separation sheet may also support the cover element and/or the bottom cover. Therefore, the separation sheet may be considered part of the battery structure and increases the structural integrity of the entire system.

The openings in the separation sheet may be formed such that the venting stream may be directed away from the cells more or less in a resistance free manner. Thus, according to an embodiment, the separation sheet has guiding surfaces for guiding the venting stream towards the opening, such as from the venting exit through the venting chamber to the opening. The separation sheet may be configured such that each venting chamber has at least one guiding surface. Such guiding surfaces may guide the venting stream away from the battery cells in a constructively simple and efficient manner. For example, the venting stream may be directed away from the cells. The separation sheet may have a plurality of guiding surfaces to direct the venting stream in different directions. For example, a first guiding surface may direct the venting stream in a first direction, and a second guiding surface may direct the venting stream in a second direction, the first and second direction being, for example, perpendicular to one another. According to an embodiment, a guiding surface of the separation sheet is arranged at a first end of the venting chamber, and the opening is arranged at a second end of the venting chamber opposite the first end such that the venting stream is guided from the venting exit along the venting side towards the opening. Thus, the venting stream receives a directional component away from the cells to the side. A further guiding surface may be arranged at the opening to even better guide the venting stream through the opening. When the venting side is a bottom side, the venting stream may be guided downwardly outside the opening. Further guiding surfaces may be provided to direct the venting stream to a center of the venting chamber.

According to an embodiment, each battery cell group forms a cell stack, and each stack includes battery cells electrically connected with one another, such as in parallel or in series. A plurality of these stacks may form a (sub)module of the battery system, and the stacks may be electrically interconnected as well. Separate venting chambers may be provided for such cell stacks because these stacks may jointly (or concurrently) experience a thermal runaway event due to, for example, heat propagation between the cells of the same stack.

According to an embodiment, the battery system includes multiple rows of battery cell groups, and a separation sheet is arranged at the venting side of the battery cell groups for each row of battery cell groups. Thus, for each of the rows, the respective separation sheet forms separate venting chambers (e.g., one venting chamber for each battery cell group) for guiding the venting stream leaving the venting exits away from the battery cell groups through openings in the separation sheet. For example, the battery system may include multiple separation sheets each providing venting chambers for multiple battery cells groups, for example, for a row of battery cells groups, with one venting chamber per group. These separation sheets may each carry their respective battery cell groups and may be structural members.

According to another embodiment of the present disclosure, a vehicle including a battery system as described above is provided. The battery system may be integrated into an underbody construction of the vehicle, which allows the battery system to have a substantially flat shape. The cover element may be a part of this underbody construction. In case of a thermal runaway, venting products are cooled down substantially by the separate venting chambers before entering the joint venting channel. Thereby, the risk of thermal propagation and, thus, thermal runaway of further cells is reduced or prevented and damage to the vehicle may be reduced or prevented.

Further aspects and features of the present disclosure can be learned from the dependent claims or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic perspective view of a battery system according to an embodiment,

FIG. 2 shows a separation sheet of the battery system shown in FIG. 1 in a schematic perspective view,

FIG. 3 is a partial cut-away view of a separation sheet taken along the line II-II of FIG. 2 with a battery cell group, and

FIG. 4 is a sectional view taken along the line III-III of FIG. 3.

### DETAILED DESCRIPTION

Reference will now be made in detail to embodiments, examples of which are illustrated in the accompanying drawings. Aspects and features of the present disclosure, and implementation methods thereof, will be described with reference to the accompanying drawings. In the drawings, like reference numerals denote like elements, and redundant descriptions thereof may be omitted. The present disclosure, however, may be embodied in various different forms and should not be construed as being limited to only the embodiments illustrated herein. Rather, these embodiments are provided as examples so that this disclosure will be thorough and complete, and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described. In the drawings, the relative sizes of elements, layers, and regions may be exaggerated for clarity. For example, in the drawings, the size or thickness of each element may be arbitrarily shown for illustrative purposes, and thus the embodiments of the present disclosure should not be construed as being limited thereto.

As used herein, the term “and/or” includes any and all combinations of one or more of the associated listed items. Further, the use of “may” when describing embodiments of the present disclosure refers to “one or more embodiments of the present disclosure.” In the following description of embodiments of the present disclosure, the terms of a singular form may include plural forms unless the context clearly indicates otherwise.

It will be understood that although the terms “first,” “second,” etc. are used to describe various elements, these elements should not be limited by these terms. These terms are only used to distinguish one element from another element. For example, a first element may be named a second element and, similarly, a second element may be named a first element, without departing from the scope of the present disclosure. As used herein, the term “and/or” includes any and all combinations of one or more of the associated listed items. Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

As used herein, the term “substantially,” “about,” and similar terms are used as terms of approximation and not as terms of degree and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

It will be further understood that the terms “have,” “include,” “comprise,” “having,” “including,” “comprising,” or variations thereof specify a property, a region, a fixed number, a step, a process, an element, a component, and a combination thereof but do not exclude other properties, regions, fixed numbers, steps, processes, elements, components, and combinations thereof.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

Herein, the terms “top” and “bottom” are defined according to the z-axis. For example, the top cover is positioned at the upper part of the z-axis, and the bottom cover is positioned at the lower part thereof.

In the following description of embodiments of the present disclosure, the terms of a singular form may include plural forms unless the context clearly indicates otherwise.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

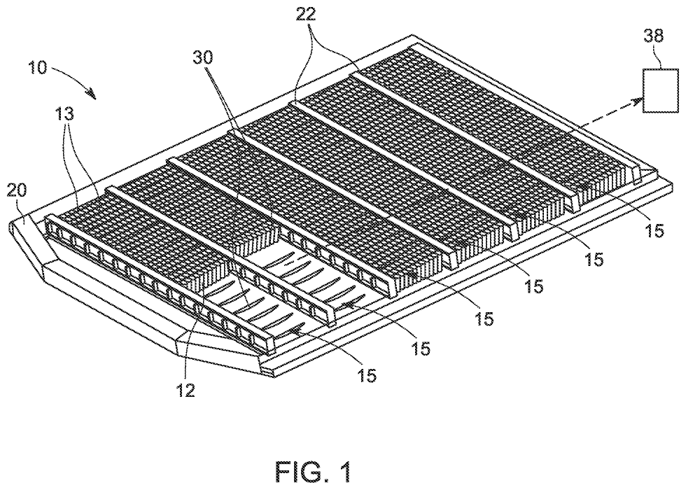

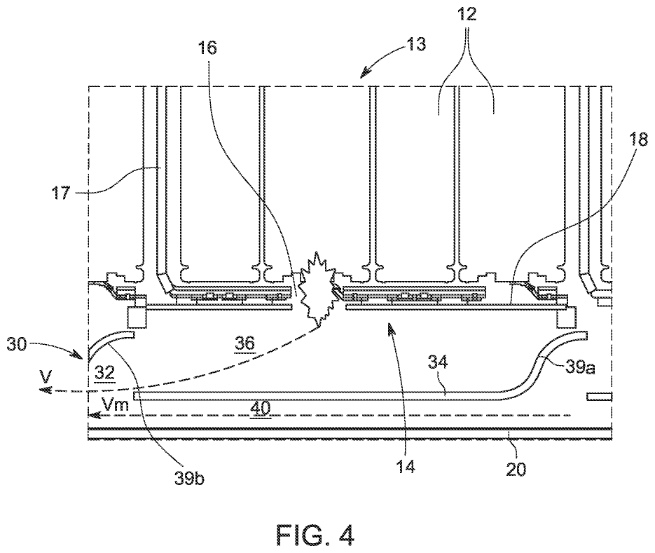

FIG. 1 shows an embodiment of a battery system 10 for an electric vehicle according to an embodiment of the present disclosure. The battery system 10 includes a plurality of battery cells 12 and a bottom cover 20, which is part of a battery housing. In this embodiment, the battery cells 12 are cylindrical cells, but they could have a different shape. The battery cells 12 are arranged in battery cell groups 13, and neighboring battery cell groups 13 are spaced apart spatially from one another along multiple rows 15. The battery cells 12 of each battery cell group 13 are electrically interconnected with one another and, thus, form a cell stack via an electrical connector 17 shown in, for example, FIG. 4. Neighboring battery cell groups 13 in the same row 15 may be electrically interconnected with one another, and the neighboring rows 15 of battery cell groups 13 may also be electrically interconnected with one another so that all of the battery cells 12 form a battery module with the battery cell groups 13 and/or rows 15 as submodules.

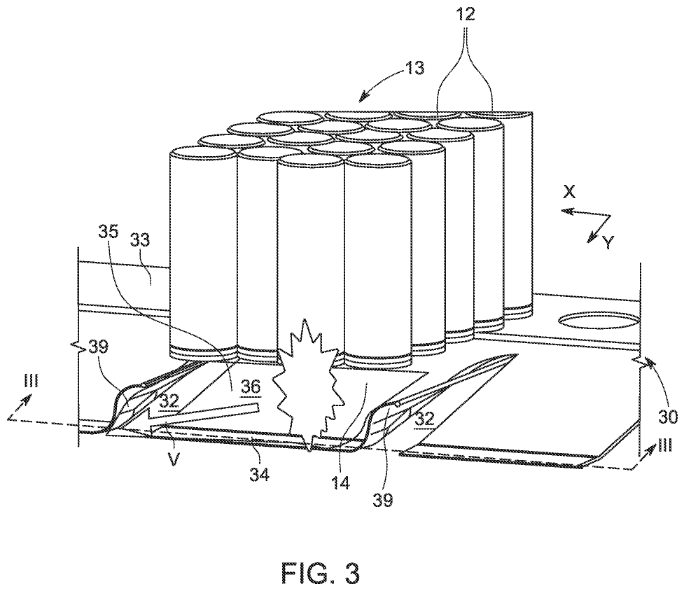

Each battery cell group 13 and, therefore, the entirety of the battery cells 12, has a venting side 14 at a bottom side. Each battery cell group has at least one venting exit 16 through which a venting stream V including venting products may exit the battery cell group 13 in case of, for example, a thermal runaway (see, e.g., FIGS. 3 and 4). Thus, the battery cells 12 are arranged to vent the venting stream downwardly towards the bottom cover 20.

The battery system 10 also includes separations sheets 30, and each row 15 of battery cell groups 13 is supported on one separation sheet 30. Each separation sheet 30 is arranged at the venting sides 14 of the corresponding battery cell group 13. In the first two rows 15 shown in FIG. 1, some of the battery cell groups 13 are not shown to allow for a view of the underlying separation sheets 30. The separation sheets 30 act as structural members carrying (or supporting) their respective battery cell groups 13. In addition, the battery system 10 includes struts 22 extending in parallel with the separation sheets 30. The struts 22 provide stability to the whole (or overall) battery system 10. The separation sheets 30 may be supported by the struts 22. The separation sheets 30 may also provide stability to the whole (or overall) battery system 10.

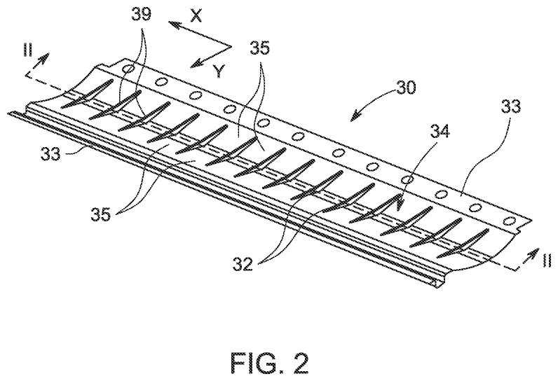

The separation sheet 30 forms separate venting chambers 36 such that there is one venting chamber 36 provided for each battery cell group 13 in each row 15. These venting chambers 16 guide the venting stream V leaving the venting exits 16 away from the battery cell groups 13 through openings 32 in the separation sheet 30, as will be explained in more detail below. FIG. 2 shows one of the separation sheets 30 with the equidistantly arranged openings 32. The separation sheet 30 has the shape of a shallow trough or channel with a depression extending along the x-axis. For example, the separation sheet 30 includes two longitudinal profile rails 33 and a downwardly tapering channel bottom 34 with sloping side walls 35. The sloping side walls 35 are sloped with respect to the y-axis as shown in FIG. 2.

When the battery cell groups 13 are arranged on the separation sheet 30, the channel bottom 34, together with the sloping side walls 35, forms the venting side 14 with a carrier element 18 and the venting chambers 36. The battery cell groups 13 are arranged on the separation sheet 30 such that one battery cell group 13 is placed between every two neighboring openings 32, as can be seen in, for example, FIGS. 3 and 4. The venting chamber 36 is delimited upwardly by the venting side 14 (or the carrier element 18) to form a first side and downwardly by the separation sheet 30 to form a second side opposite the first side. The venting chamber 36 is further delimited to the sides (e.g., to the lateral sides) by sidewall members 39. The separation sheet 30 may be formed via deep drawing a sheet, such as a metal sheet. By such a drawing method, the venting chamber 36 including the sidewall members 39 may be drawn. The openings 32 may be formed at the same time (e.g., concurrently). The sidewall members 39 can be seen in, for example, FIG. 4.

In a first step of a thermal runaway event, a venting stream V including hot venting gasses and products leaves (e.g., is emitted by or from) the battery cell group 13, as shown in FIGS. 3 and 4, at the venting side 14 through the venting exit 16. In some embodiments, a venting valve may be provided at the venting exit 16. In a second step of the thermal runaway event, the venting gas expands into the venting chamber 36 such that the pressure of the venting gas and, due to the thermal mass of the venting chamber 36, the temperature of the venting gas is reduced. Also, the venting stream V is guided down the sloping side walls 35 of the separation sheet 30 to the center of the channel bottom 34 and, therefore, to the center of the venting chamber 36. In other words, the sloping side walls 35 act as first guiding surfaces. The sloping side walls 35 are shown in FIG. 3. The sidewall members 39 may act as second guiding surfaces. The right-side sidewall member 39a guides the venting stream V to the left towards the left-side sidewall member 39b, and the left-side sidewall member 39b guides the venting stream V through the opening 32. As can be seen in, for example, FIG. 4, the sidewall member 39 of one venting chamber 36 act not only as a guiding surface for the venting stream of this venting chamber 36 but also as a guiding surface for the venting stream of a neighboring cell chamber because the sidewall members 39 form dividing walls separating two neighboring cell chambers.

In a third step of a thermal runaway event, the venting stream V is channelled away from the battery cell group 13 through the opening 32 into a venting channel 40, which is arranged between the separation sheet 30 and the bottom cover 20 (see, e.g., FIG. 4). The venting stream V may join a main venting stream Vₘ flowing along the venting channel 40 when it enters the venting channel 40. The main venting stream Vₘ may include the venting streams of other battery cell groups. The venting channel 40 connects (e.g., fluidly connects or flows to) a system exit 38 of the battery housing, which is shown schematically in FIG. 1, with the venting chambers 36 via the openings 32. In a fourth step of the thermal runaway event, a venting valve provided at the system exit 38 opens at a certain (e.g., a reference) pressure to release the main venting stream Vₘ to the environment of the battery system 10.

Due to the venting chambers 36, a venting stream V leaving one of the battery cell groups 13 does not directly enter the venting channel 40 but instead first passes through the venting chamber 36. The venting chamber 36, due to its thermal mass, reduces the temperature of the venting stream before the venting stream V enters the joint/main venting channel 40. The venting chamber 36, thus, acts as a buffer space for the venting stream V where the venting stream V is pre-cooled before entering the venting channel 40. Further, the battery cell groups 13 are protected by the separation sheet 30 and its dedicated venting chambers 36 and side walls (e.g., guiding surfaces) 35, 39, which lead the venting stream V away from the battery cells 12 towards the opening 32. The venting products are, therefore, not deposited onto the battery cells. The separation sheet 30, thus, also cats as a baffle.

The disclosed venting geometry provides sufficient cool-down of the venting products before leaving the respective venting chamber so that the risk of damaging other cells via heat propagation is reduced. Also, the venting chambers shield the respective battery cell group from a venting stream leaving another (e.g., an adjacent) venting chamber because the venting stream cannot easily enter other venting chambers. Further, the venting products exiting the battery system towards the environment are at a relatively lower temperature.

### SOME REFERENCE SIGNS

10 battery system
12 battery cells
13 battery cell groups
14 venting side
15 rows of battery cell groups
16 venting exit
17 connecting means
18 carrier element
20 bottom cover
22 struts
30 separation sheet
32 openings in the separation sheet
33 profile rails
34 channel bottom
35 sloping side walls
36 venting chamber
38 system exit
40 main venting channel
V venting stream
Vₘ main venting stream

What is claimed is:

1. A battery system comprising:
a battery housing;
a plurality of battery cells arranged in a plurality of battery cell groups within the battery housing, each battery cell group has a venting side with a venting exit configured to vent a venting stream from the battery cells to exit the battery cell group; and
a separation sheet at the venting sides of the battery cell groups, the separation sheet forming separate venting chambers for each of the battery cell groups, the separation sheet being configured to guide the venting stream leaving the venting exits away from the battery cell groups through openings in the separation sheet.

2. The battery system of claim 1, further comprising a cover element facing the venting side of the battery cell groups,
wherein the separation sheet is arranged between the cover element and the venting side of the battery cell groups,
wherein a venting channel is arranged between the separation sheet and the cover element, the venting channel fluidly connecting a system exit of the battery housing with the venting chambers via the openings in the separation sheet.

3. The battery system of claim 2, wherein the cover element is a bottom cover.

4. The battery system of claim 3, wherein the bottom cover is part of an underbody of the battery housing.

5. The battery system of claim 1, wherein the battery cell groups are supported by the separation sheet.

6. The battery system of claim 5, wherein the separation sheet is a structural member of the battery system.

7. The battery system of claim 1, wherein the separation sheet comprises guiding surfaces configured to guide the venting stream towards the opening.

8. The battery system of claim 7, wherein a first one of the guiding surfaces is at a first end of the venting chamber, and the opening is at a second end of the venting chamber opposite the first end such that the venting stream is guided from the venting exit along the venting side towards the opening.

9. The battery system of claim 1, wherein each of the battery cell groups is a cell stack, and each of the cell stacks comprising battery cells electrically connected with one another.

10. The battery system of claim 1, wherein the battery cell groups are arranged in multiple rows,
wherein for each row of the battery cell groups, the separation sheet is arranged at the venting side of the battery cell groups, the separation sheet forming separate venting chambers for each of the battery cell groups in the respective row for guiding the venting stream leaving the venting exits away from the battery cell groups through openings in the separation sheet.

11. An electric vehicle comprising the battery system according to claim 1.
